(19) United States
(12) Patent Application Publication
(10) Pub. No.: US 2011/0170472 A1
(43) Pub. Date: Jul. 14, 2011

(54) METHOD FOR ALLOCATING PHYSICAL LAYER CONTROL INFORMATION FOR MBMS AND METHOD FOR RECEIVING PHYSICAL LAYER CONTROL INFORMATION FOR MBMS THEREFOR

(75) Inventors: Taegyun Noh, Daejeon (KR); Jae-Heung Kim, Daejeon (KR); Jae-Young Ahn, Daejeon (KR)

(73) Assignee: Electronics and Telecommunications Research Institute, Daejon (KR)

(21) Appl. No.: 13/120,779

(22) PCT Filed: Sep. 28, 2009
(86) PCT No.: PCT/KR2009/005542

§ 371 Date: Mar. 24, 2011

(30) Foreign Application Priority Data
Sep. 29, 2008 (KR) 10-2008-0095503
Sep. 30, 2008 (KR) 10-2008-0096127

(51) Int. Cl. H04H 20/71

(52) U.S. Cl. 370/312

(57) ABSTRACT

Provided are a method for allocating physical layer control information for multimedia broadcast multicast service (MBMS) and a method for receiving physical layer control information in a wireless communication system for MBMS. The method for allocating physical layer control information for MBMS includes generating physical layer control information for MBMS, and allocating the physical layer control information to a common search space and a specific search space.

### TECHNICAL FIELD

The present invention relates to a method for allocating physical layer control information and a method for receiving physical layer control information in a wireless communication system; and more particularly, to a method for allocating physical layer control information for multimedia broadcast multicast service (MBMS) and a method for receiving physical layer control information in a wireless communication system for MBMS.

### BACKGROUND ART

In general, one base station provides various services to a plurality of mobile stations in a wireless communication system. One of representative communication services that the base station provides is a multimedia broadcast multicast service (MBMS). Unlike a one-to-one communication service such as a unicast service, the MBMS is a one-to-many communication service. That is, one base station simultaneously provides MBMS to a plurality of mobile stations. Like a cell broadcast service (CBS), the MBMS transmits the identical information to a plurality of mobile stations at the same time. The CBS is a slow speed message based service. Unlike the CBS, the MBMS is to transmit multimedia data at a high speed.

FIGS. 1 and 2 are diagrams illustrating a unicast service and a multimedia broadcast multicast service (MBMS).

FIG. 1 is a diagram illustrating a unicast service.

Referring to FIG. 1, a base station 101 or a node B individually transmits traffic to a plurality of mobile stations or user equipment 103, 105, and 107. That is, each one of the mobile stations 103, 105, and 107 receives different traffic using a dedicated traffic channel.

FIG. 2 is a diagram illustrating MBMS.

Referring to FIG. 2, a base station 201 transmits the same MBMS traffic to a plurality of mobile stations 203, 205, and 207. Each one of the plurality of mobile stations 203, 205, and 207 receives the same MBMS traffic and a user selects a desired service in the received MBMS traffic to use a broadcast service.

A wireless communication system transmits data (traffic information) and control information of a service through a physical layer. A base station transmits physical layer control information such as Downlink Control information (DCI) to a mobile station in order to enable the mobile station to receive data and control information according to a service.

The mobile station receives the physical layer control information and may receive traffic information, system information, or paging information according to a service using the received physical layer control information.

That is, the physical layer control information is information about controlling receiving system information, paging information, and traffic information transmitted through a physical layer. The physical layer control information also includes information about a resource location, a size of information, a modulation scheme, and a code rate. The system information denotes properties of a cell such as a bandwidth of a cell of a wireless communication system.

In a unicast service, physical layer control information is allocated to a common search space or a specific search space and transmitted to a mobile station. Here, a space means a location on a resource (a physical area on a resource). The physical area where information is located on a resource can be expressed by a mapping function. The mobile station can receive the physical layer control information by searching a search space.

In detail, the physical layer control information about common information for a plurality of users, such as system information or paging information, is allocated to a common search space and transmitted to a mobile station. The physical layer control information about uplink or downlink traffic information of each user is allocated to a specific search space and transmitted to a mobile station. According to a resource size of information, physical layer control information about uplink traffic information or downlink traffic information is allocated to a common search space and transmitted to a mobile station.

### DISCLOSURE

### Technical Problem

An embodiment of the present invention is directed to providing a method for allocating physical layer control information for multimedia broadcast multicast service (MBMS) and a method for receiving physical layer control information for MBMS in a wireless communication system.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for allocating physical layer control information for multimedia broadcasting multicast service (MBMS), including generating physical layer control information for MBMS and allocating the physical layer control information to a common search space and a specific search space.

In accordance with another aspect of the present invention, there is provided a method for allocating physical layer control information for multimedia broadcasting multicast service (MBMS), including generating physical layer control information for MBMS, and allocating the physical layer control information into a common search space, a MBMS control information search space, and a MBMS traffic information search space.

In accordance with another aspect of the present invention, there is provided a method for receiving physical layer control information for multimedia broadcasting multicast service (MBMS), including receiving physical layer control information for MBMS, which is allocated to a predetermined search space and transmitted from a base station and decoding the received physical layer control information.

### Advantageous Effects

According to the present invention, physical layer control information for MBMS is allocated to a predetermined search space and transmitted in a wireless communication system. Therefore, a mobile station can effectively receive physical layer control information by searching the predetermined search space with the physical layer control information allocated.

### BRIEF DESCRIPTION OF THE DRAWINGS

FIGS. 1 and 2 are diagrams illustrating a unicast service and a multimedia broadcast system according to the related art.

FIG. 3 is a flowchart illustrating a method for allocating physical layer control information for MBMS in accordance with an embodiment of the present invention.

FIG. 4 is a diagram illustrating a search space allocated to physical layer control information for MBMS.

FIG. 5 is a flowchart illustrating a method for allocating physical layer control information for MBMS in accordance with a second embodiment of the present invention.

FIG. 6 is a diagram illustrating a search space allocated to physical layer control information for MBMS in FIG. 5.

FIG. 7 is a diagram illustrating a structure of a subframe.

FIG. 8 is a flowchart illustrating a method for receiving physical layer control information for MBMS in accordance with an embodiment of the present invention.

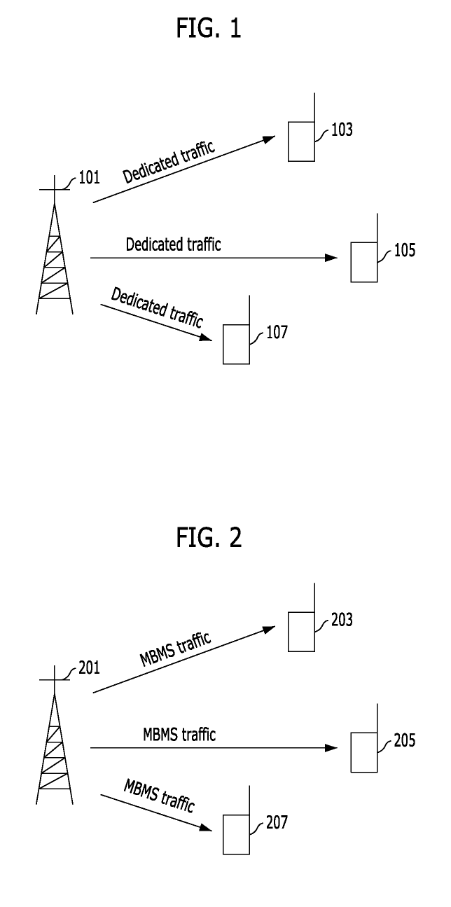

### BEST MODE FOR THE INVENTION

The advantages, features and aspects of the invention will become apparent from the following description of the embodiments with reference to the accompanying drawings, which is set forth hereinafter. In addition, if further detailed description on the related prior arts is determined to obscure the point of the present invention, the description is omitted. Hereafter, preferred embodiments of the present invention will be described in detail with reference to the drawings. The same reference numeral is given to the same element, although the element appears in different drawings.

In a wireless communication system, a base station for providing a MBMS transmits MBMS traffic information, MBMS control information, and system information or paging information which is common information in a communication service provided from a wireless communication system. The base station transmits physical layer control information for MBMS traffic information, MBMS control information, system information, and paging information in order to enable a mobile station to receive the MBMS traffic information, the MBMS control information, the system information, and the paging information.

Here, a method for allocating physical layer control information for MBMS according to an embodiment of the present invention allocates physical layer control information for MBMS into a common search space and a specific search space or a common search space, a MBMS control information search space, and a MBMS traffic information search space.

A mobile station receives physical layer control information for MBMS by searching a common search space and a specific search space according to necessary information or by searching a common search space, a MBMS control information search space, and a MBMS traffic information search space. Therefore, the mobile station can effectively receive the physical layer control information.

Hereinafter, a method for allocating physical layer control information for MBMS in accordance with an embodiment of the present invention will be described with the accompanying drawings.

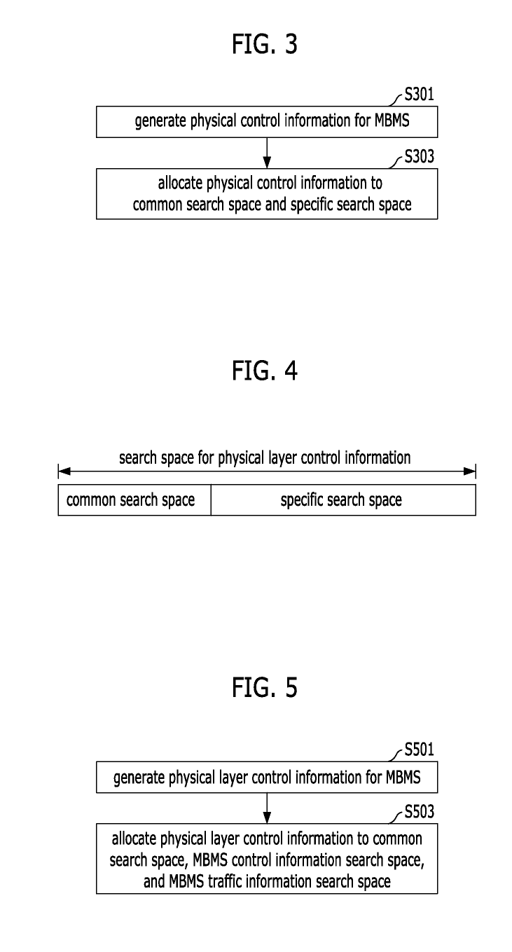

FIG. 3 is a flowchart illustrating a method for allocating physical layer control information for MBMS in accordance with a first embodiment of the present invention.

Referring to FIG. 3, the method for allocating physical layer control information for MBMS according to the present embodiment starts with step S301.

At step S301, a base station generates physical layer control information for MBMS. The base station may generate physical layer control information for MBMS in response to a request of a MBMS user or a broadcasting service provider. As described above, the physical layer control information for MBMS is information about locations of MBMS traffic information, MBMS control information, system information, and paging information on a resource, resource sizes, a modulation scheme, and a code rate for MBMS traffic information, MBMS control information, system information, and paging information.

At step S303, the base station allocates the generated physical layer control information to a common search space and a specific search space. FIG. 4 illustrates a search space allocated to physical layer control information for MBMS. Referring to FIG. 4, the physical layer control information for MBMS can be allocated to a common search space and a specific search space.

The physical layer control information for MBMS can be allocated to a common search space and a specific search space like the physical layer control information for a unicast service. However, the physical layer control information for MBMS allocated to each one of the common search space and the specific search space is different from allocated physical layer control information for a unicast service due to MBMS property.

In detail, among MBMS control information, physical layer control information for common control information for a mobile station using MBMS is allocated to the common search space. Further, physical layer control information for the MBMS traffic information or physical layer control information for non-common control information in the MBMS control information is allocated to the specific search space. The system information and the paging information may be additionally allocated to the common search space.

The MBMS control information is control information for providing MBMS. For example, the MBMS control information may be information about a transmission order of MBMS traffic information transmitted from a base station. The MBMS control information may include common control information and non-common control information for a mobile station using MBMS.

For example, disaster broadcasting is a public broadcasting service. Accordingly, it is necessary to provide the disaster broadcasting to all mobile stations using MBMS. Control information for such disaster broadcasting is common control information. For example, when some MBMS users select only a terrestrial broadcasting service or select only a cable broadcasting service, non-common control information is transmitted to a mobile station according to a MBMS service selection of a user.

That is, at step S303, a base station allocates physical layer control information for common control information in the MBMS control information for a MBMS mobile station to a common search space or the base station allocates physical layer control information for MBMS traffic information or physical layer control information for non-common control information in the MBMS control information to a specific search space. That is, at step S303, the base station allocates physical layer control information for MBMS to a common search space and a specific search space.

Meanwhile, at step S303, the base station may allocate physical layer control information for MBMS control information to the common search space and allocate physical layer control information for MBMS traffic information to the specific search space.

That is, the base station allocates physical layer control information for MBMS control information which includes common control information and non-common control information to a common search space and allocates physical layer control information for MBMS traffic information to a specific search space.

The base station transmits the physical layer control information for MBMS to the mobile station using a method for allocating physical layer control information for MBMS according to the present embodiment. Then, a mobile station user can use a broadcasting service from a selected wireless communication service provider such as disaster broadcasting, terrestrial broadcasting, or cable broadcasting.

The mobile station can receive the physical layer control information for MBMS by searching the common search space and the specific search space. It will be described in later with reference to FIG. 8.

FIG. 5 is a flowchart illustrating a method for allocating physical layer control information for MBMS in accordance with a second embodiment of the present invention.

As shown in FIG. 5, the method for allocating physical layer control information for MBMS according to the present embodiment starts with step S501.

At step S501, a base station generates physical layer control information for MBMS. The process step S501 corresponds to the process step S301 of FIG. 3.

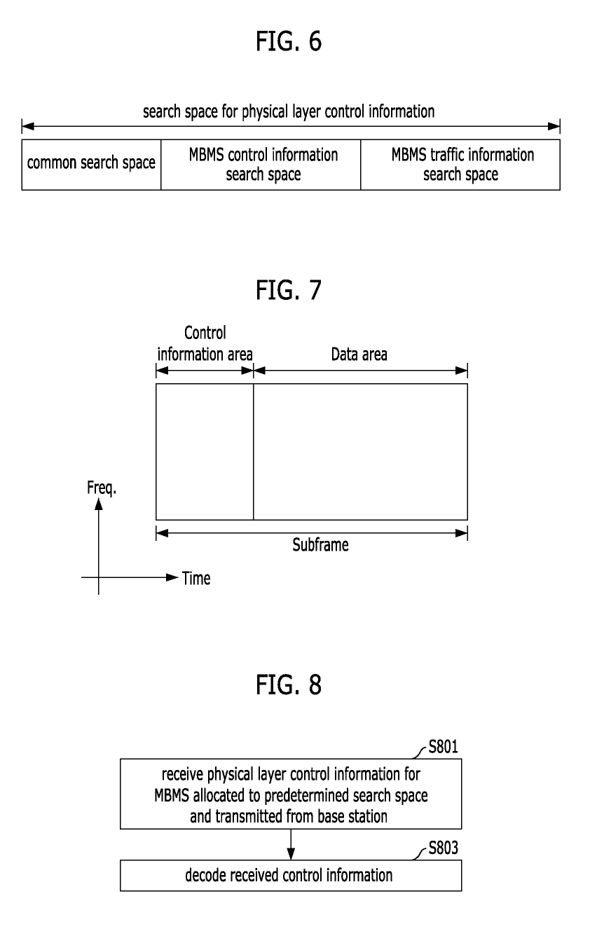

At step S503, the base station allocates the generated physical control information to a common search space, a MBMS control information search space, and a MBMS traffic information search space. FIG. 6 illustrates a search space for allocating physical layer control information for MBMS. Referring to FIG. 6, the physical layer control information for MBMS may be allocated to the common search space and the specific search space. Unlike FIG. 3, the physical layer control information for MBMS is allocated to three spaces in FIG. 5.

In more detail, physical layer control information for common control information in MBMS control information for a mobile station using MBMS is allocated to the common search space. Physical layer control information for non-common control information in MBMS control information is allocated to the MBMS control information search space. Physical layer control information for MBMS traffic information is allocated to the MBMS traffic information search space. System information and paging information may be additionally allocated to the common search space.

In detail, at step S503, the base station performs three allocating processes according to physical layer control information allocated to the MBMS control information search space and the MBMS traffic information search space. That is, the base station allocates physical layer control information for common control information in MBMS control information for a mobile station using MBMS to the common search space, allocates physical layer control information for non-common control information in the MBMS control information to the MBMS control information search space, and allocates physical layer control information for MBMS traffic information to the MBMS traffic information search space.

That is, the process step S503 includes a process for allocating physical layer control information for MBMS to the common search space, a process for allocating physical layer control information for MBMS to a MBMS control information search space, and a process for allocating physical layer control information for MBMS to a MBMS traffic information search space.

Meanwhile, the process step S503 may include allocating physical layer control information for system information and paging information to the common search space, allocating physical layer control information for MBMS control information to the MBMS control information search space, and allocating physical layer control information for MBMS traffic information to the MBMS traffic information search space.

The physical layer control information for MBMS allocated into each search space shown in FIGS. 3 and 5 can be identified by an identifier (ID). That is, the base station may assign an identifier (ID) such as Radio Network Temporary identifier (RNTI) according to a type of physical layer control information for MBMS allocated each search space while allocating the physical layer control information such as step S303 or S503. Therefore, the mobile station can identify a plurality of physical layer control information allocated to each search space using the identifiers assigned to the plurality of physical layer control information.

For example, the MBMS control information is assigned with an identifier according to whether the MBMS control information is common control information for all MBMS users, necessary control information per MBMS traffic, necessary control information per MBMS traffic group, common control information for a plurality of MBMS traffics, or common control information for a plurality of MBMS traffic groups. Here, the MBMS traffic group is a group of similar types of MBMS traffic. For example, a MBMS traffic group may be classified into a terrestrial MBMS traffic group or a cable broadcasting MBMS traffic group.

Meanwhile, an area of physical layer control information in each search space, which is a physical area of a resource, can be changed according to an identifier, a total amount of resources for transmitting physical layer control information for MBMS, or an amount of each physical layer control information allocated to each search space.

A structure of a subframe will be described with reference to FIG. 7. The physical layer control information for MBMS is included in a control information area of a subframe. The MBMS traffic information, the MBMS control information, the system information, or the paging information may be included in a data area of the subframe. That is, the physical layer control information for MBMS may be physically placed in a control information area with an identifier. Also, the MBMS traffic information, the MBMS control information, the system information, or the paging information may be physically placed in a data area.

Sizes of the control information area and the data area may be changed according to a resource amount of the physical layer control information for MBMS. Locations of the physical layer control information for MBMS on resources also can be changed. That is, an area of physical layer control information for MBMS can be changed in each search space.

For example, the control information area may be a physical downlink control channel (PDCCH) and the data area may be a physical downlink shared channel (PDSCH) in an orthogonal frequency division multiplexing (OFDM) system. An OFDM symbol allocated to the PDCCH and the PDSCH may be changed according to a resource amount of physical layer control information for MBMS. Also, locations of the physical layer control information for MBMS on resources may also be changed. Finally, an area of physical layer control information for MBMS can be changed in each search space.

A factor for deciding an area of each one of physical layer control information may be different in each search space. That is, an identifier can decide a location of physical layer control information in a search space, and an identifier or a resource amount of physical layer control information may decide a location of physical layer control information in a different search space.

Meanwhile, it is preferable that each one of physical layer control information is allocated only in a search space among a plurality of search spaces. Further, it is preferable not to allocate the same physical layer control information to more than two search spaces.

According to the embodiments of the present invention, the physical layer control information for MBMS is allocated to a predetermined search space. When a mobile station uses a MBMS, the mobile station searches the common search space or the MBMS control information search space at first and searches a MBMS traffic information search space according to a broadcasting service. Therefore, the mobile station spends a short search time and uses less power for searching the physical layer control information for MBMS. Further, the mobile station may have simple hardware configuration for search.

Since the physical layer control information for MBMS including an identifier such as RNTI is transmitted according to the embodiments of the present invention, the mobile station can effectively receive target physical layer control information in each search space using an identifier.

FIG. 8 is a flowchart illustrating a method for receiving physical layer control information for MBMS in accordance with an embodiment of the present invention.

Referring to FIG. 8, the method for receiving physical layer control information for MBMS according to the present embodiment starts with step S801.

At step S801, a mobile station receives physical layer control information for MBMS that is transmitted from a base station and allocated to a predetermined search space. The predetermined search space may be a common search space, a specific search space, a MBMS control information search space, and a MBMS traffic information search space shown in FIGS. 3 and 5. That is, the mobile station can receive the physical layer control information, which is allocated to the predetermined space according to the method for allocating physical layer control information according to the present embodiment, by searching the physical layer control information in the predetermined space.

At step S803, the mobile station decodes the received control information. In detail, the mobile station can decode necessary information or corresponding information using an identifier assigned to the physical layer control information allocated to the predetermined search space. For example, when an identifier assigned to physical layer control information is RNTI, the mobile station may perform blind decoding using the identifier assigned to the physical layer control information and RNTI assigned to the mobile station itself. Then, the mobile station determines whether the decoded physical layer control information is necessary information or information about the mobile station itself.

As described above, the method for allocating physical layer control information and the method for receiving physical layer control information according to the present embodiment were described in view of process. Each process step of the method for allocating physical layer control information and the method for receiving physical layer control information according to the present embodiment can be analyzed in a mechanical view point. Therefore, each process step of the method for allocating physical layer control information and the method for receiving physical layer control information according to the present embodiment may be understood as constituent elements includes an apparatus for allocating physical layer control information and an apparatus for receiving physical layer control information according to the present embodiment.

The method for allocating physical layer control information and the method for receiving physical layer control information according to the present embodiment can be composed as a computer program. A computer programmer can easily reason codes or code segments of the computer program. Also, the computer program can be stored in computer readable recording medium (information recording medium) and the methods according to the present invention can be read and realized by the computer. The computer readable recording medium includes all types of recording mediums including not only tangible medium such as CD and DVD but also intangible medium such as a carrier wave

The present application contains a subject matter related to Korean Patent Application No. 10-2008-0095503, filed in the Korean Intellectual Property Office on Sep. 29, 2008, and the Korean Patent Application No. 10-2008-0096127, filed in the Korean Intellectual Property Office on Sep. 30, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. A method for allocating physical layer control information for multimedia broadcasting multicast service (MBMS), comprising:
generating physical layer control information for MBMS; and
allocating the physical layer control information to a common search space and a specific search space.

2. The method of claim 1, wherein said allocating the physical layer control information includes:
allocating physical layer control information for common control information in MBMS control information for a mobile station using the MBMS to the common search space; and
allocating physical layer control information for MBMS traffic information or physical layer control information for non-common control information in the MBMS control information to the specific search space.

3. The method of claim 1, wherein said allocating the physical layer control information includes:
allocating physical layer control information for MBMS control information to the common search space; and
allocating physical layer control information for MBMS traffic information to the specific search space.

4. The method of claim 2, wherein in said allocating the physical layer control information, an identifier is assigned according to a type of information allocated to each search space.

5. The method of claim 4, wherein the information allocated to each search space is placed in a physical area of the search space, which is decided according to the identifier or a resource amount of the physical layer control information.

6. A method for allocating physical layer control information for multimedia broadcasting multicast service (MBMS), comprising:
generating physical layer control information for MBMS; and
allocating the physical layer control information into a common search space, a MBMS control information search space, and a MBMS traffic information search space.

7. The method of claim 6, wherein said allocating the physical layer control information includes:
allocating physical layer control information for common control information in MBMS control information for a mobile station using the MBMS to the common search space;
allocating physical layer control information for non-common control information in the MBMS control information to the MBMS control information search space; and
allocating physical layer control information for MBMS traffic information into the MBMS traffic information search space.

8. The method of claim 6, wherein said allocating the physical layer control information includes:
allocating physical layer control information for system information and paging information to the common search space;
allocating physical layer control information for MBMS control information to the MBMS control information search space; and
allocating physical layer control information for MBMS traffic information to the MBMS traffic information search space.

9. The method of claim 7, wherein in said allocating the physical layer control information, an identifier is assigned according to a type of information allocated to each search space.

10. The method of claim 9, wherein the information allocated to each search space is placed in a physical area of the search space, which is decided according to the identifier or a resource amount of the physical layer control information.

11. A method for receiving physical layer control information for multimedia broadcasting multicast service (MBMS), comprising:
receiving physical layer control information for MBMS, which is allocated to a predetermined search space and transmitted from a base station; and
decoding the received physical layer control information.

12. The method of claim 11, wherein the predetermined search space includes:
a common search space configured to allocate physical layer control information for common control information in MBMS control information for a mobile station using the MBMS; and
a specific search space configured to allocate physical layer control information for MBMS traffic information or physical layer control information for non-common control information in the MBMS control information.

13. The method of claim 11, wherein the predetermined search space includes:
a common search space configured to allocate physical layer control information for MBMS control information; and
a specific search space configured to allocate physical layer control information for MBMS traffic information.

14. The method of claim 11, wherein the predetermined search space includes:
a common search space configured to allocate physical layer control information for common control information in MBMS control information for a mobile station using the MBMS;
a MBMS control information search space configured to allocate physical layer control information for non-common control information in the MBMS control information; and
a MBMS traffic information search space configured to allocate physical layer control information for MBMS traffic information.

15. The method of claim 11, wherein the predetermined search space includes:
a common search space configured to allocate physical layer control information for system information or paging information;
a MBMS control information search space configured to allocate physical layer control information for MBMS control information; and
a MBMS traffic information search space configured to allocate physical layer control information for MBMS traffic information.

16. The method of claim 3, wherein in said allocating the physical layer control information, an identifier is assigned according to a type of information allocated to each search space.

17. The method of claim 8, wherein in said allocating the physical layer control information, an identifier is assigned according to a type of information allocated to each search space.
